(19) United States
(12) Patent Application Publication
(10) Pub. No.: US 2008/0000230 A1
(43) Pub. Date: Jan. 3, 2008

(54) Exhaust Gas Recirculation System

(75) Inventor: Aaron D. Strauser, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/765,371

(22) Filed: Jun. 19, 2007

Related U.S. Application Data
(60) Provisional application No. 60/817,808, filed on Jun. 30, 2006.

(51) Int. Cl. F02B 33/44

(52) U.S. Cl. 60/605.2; 60/612

(57) ABSTRACT

A system for recirculating exhaust gas in an engine system includes a turbocharger and an exhaust gas recirculation system. The turbocharger includes a turbine driven by the exhaust gas from an engine, and a compressor operatively connected to the turbine. The compressor includes an air inlet and a diffuser portion located downstream of the air inlet. The exhaust gas recirculation system includes a fluid passage having an inlet fluidly connected to an outlet of the engine, and an outlet fluidly connected to the diffuser portion of the compressor and located downstream of the air inlet of the compressor.

### TECHNICAL FIELD

The present disclosure relates generally to exhaust gas recirculation systems, and more particularly, to exhaust gas recirculation systems providing exhaust gas to a compressor of a turbocharger.

### BACKGROUND

Exhaust gas recirculation (EGR) systems are used for controlling emissions of undesirable pollutant gases and particulates in an operation of an internal combustion engine. Such systems have proven particularly useful in internal combustion engines used in motor vehicles such as passenger cars, trucks, and other on-road machines. EGR systems primarily recirculate exhaust gas into an intake air supply of the internal combustion engine. The exhaust gas which is reintroduced to the engine cylinder reduces the concentration of oxygen therein, which in turn lowers the maximum combustion temperature within the cylinder and slows the chemical reaction of the combustion process, decreasing the formation of nitrous oxides (NOₓ). Furthermore, the exhaust gas typically contains unburned hydrocarbons which are burned on reintroduction into the engine cylinder to further reduce the emission of undesirable pollutants from the internal combustion engine.

One method of providing an EGR is described in U.S. Pat. No. 6,899,090 (the '090 patent) issued to Arnold. The '090 patent describes a system and method for dual path EGR, utilizing a high pressure EGR loop, primarily for use under mid and high load engine conditions, and a low pressure EGR loop, primarily for use under low load engine conditions. Although the system of the '090 patent may be effective for increasing operating efficiency in certain situations and for decreasing the formation of nitrous oxides, the system of the '090 patent includes several disadvantages. For example, the recirculated exhaust gas is mixed with compressor inlet air at the inlet of the compressor. In such an arrangement, the compressor seals and/or compressor impeller may be subject to corrosion resulting from the pollutants in the EGR flow. Furthermore, it is necessary to increase the diameter of the compressor impeller due to increased gas flow required by the EGR.

The disclosed system is directed to overcoming one or more of the problems set forth above.

### SUMMARY OF THE INVENTION

In one aspect, the present disclosure is directed to a system for recirculating exhaust gas in an engine system. The system for recirculating exhaust gas may include a turbocharger and an exhaust gas recirculation system. The turbocharger may include a turbine driven by the exhaust gas from an engine, and a compressor operatively connected to the turbine. The compressor may include an air inlet and a diffuser portion located downstream of the air inlet. The exhaust gas recirculation system may include a fluid passage having an inlet fluidly connected to an outlet of the engine, and an outlet fluidly connected to the diffuser portion of the compressor and located downstream of the air inlet of the compressor.

In another aspect, the present disclosure is directed to a method for providing exhaust gas recirculation for an engine system. The engine system may include a turbocharger having a turbine and a compressor operatively connected to the turbine. The compressor may include an air inlet and a diffuser portion connected downstream of the air inlet. Exhaust gas may be emitted from an engine to form a flow of exhaust gas, and at least a portion of the flow of exhaust gas may be directed directly into the diffuser portion of the compressor.

In yet another aspect, the present disclosure is directed to an engine system that may include an intake system configured to supply fluid to an engine, an exhaust system configured to receive exhaust gas leaving the engine, and an exhaust gas recirculation system. A first turbocharger may include a first turbine forming a part of the exhaust system and having an inlet and an outlet, and a first compressor operatively connected to the first turbine and, forming a part of the intake system and having an inlet and an outlet. The first compressor may include a diffuser portion fluidly connected downstream of the inlet of the first compressor. A second turbocharger may include a second turbine forming a part of the exhaust system and having an inlet and an outlet, and a second compressor operatively connected to the second turbine and, forming a part of the intake system and having an inlet and an outlet. The inlet of the second turbine may be fluidly connected to the outlet of the first turbine. The outlet of the second compressor may be fluidly connected to the inlet of the first compressor. The second compressor may include a diffuser portion fluidly connected downstream of the inlet of the second compressor. The exhaust gas recirculation system may have a fluid passage extending between the exhaust system and the intake system. The fluid passage may be directly connected to the diffuser portion of one of the first compressor and the second compressor.

### BRIEF DESCRIPTION OF THE DRAWINGS

FIG. 1 is a schematic diagram illustration of an exemplary embodiment of a system for recirculating exhaust gas in an engine system according to principles of the disclosure;

FIG. 2 is a sectional view of a compressor according to an exemplary EGR system of the disclosure; and

FIG. 3 is schematic diagram illustration of another exemplary embodiment of a system for recirculating exhaust gas according to principles of the disclosure.

### DETAILED DESCRIPTION

The present disclosure is directed to an internal combustion engine system having a system for recirculating exhaust gas. The internal combustion engine system may be any type of engine. For example, the internal combustion engine may be associated with a fixed or mobile machine that performs an operation associated with an industry such as mining, construction, farming, transportation, or any other similar industry known. Such machines may include, for example, an earth moving machine such as an excavator, a dozer, a loader, a backhoe, a motor grader, a dump truck, or any other earth moving machine.

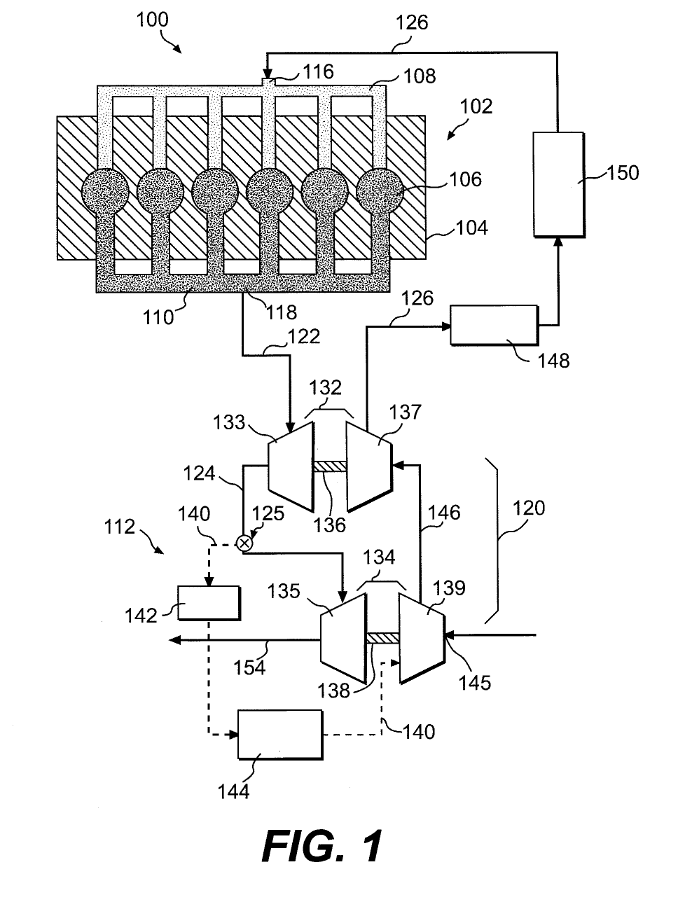

Referring to FIG. 1, there is shown a schematic diagram of an exemplary internal combustion engine system 100 having an internal combustion engine 102. The engine 102 may be any type of engine, including, but not limited to, diesel, gasoline or gaseous fuel driven engine. The engine 102 may include an engine block 104 defining a plurality of combustion cylinders 106, the number of which depends on the particular application. In the exemplary engine 102, six combustion cylinders 106 are shown, however, it should be appreciated that any number of combustion cylinders 106 may be applicable to the present disclosure. There may be associated with each combustion cylinder 106, a fuel injector, a cylinder liner, at least one air intake port and corresponding intake valve, at least one exhaust gas port and corresponding exhaust valve, and a reciprocating piston moveable within each combustion cylinder 106 (some of the above elements are not shown). The engine 102 may include an intake system 103A and an exhaust system 103B. The intake system 103A may include an intake manifold 108 having an air inlet 116 and the exhaust system 103B may include an exhaust manifold 110 having an exhaust gas outlet 118.

The engine system 100 may further include a turbocharger system 120, which may include a traditional turbocharger known in the art, a motor driven turbocharger, a supercharger, or the like. The turbocharger system 120 may include a first turbocharger 132 and a second turbocharger 134. The first and second turbochargers 132, 134 may be arranged in series with each other such that, for intake air to the engine 102, the second turbocharger 134 provides a first stage of pressurization and the first turbocharger 132 provides a second stage of pressurization. In one embodiment, the second turbocharger 134 may be a low-pressure turbocharger and the first turbocharger 132 may be a high-pressure turbocharger with respect to the engine intake air. Each of the first and second turbochargers 132, 134 may include a turbine 133, 135, respectively, forming a part of the exhaust system 103B, and a compressor 137, 139, respectively, forming a part of the intake system 103A. Each turbine has an inlet and an outlet. Each compressor has an inlet and an outlet. The inlet of the first turbine 133 is fluidly connected to the exhaust gas outlet 118 of the engine 102 via an exhaust gas conduit 122. The inlet of the second turbine 135 is fluidly connected to the outlet of the first turbine 133 via an inter-conduit 124. Each of the turbines 133, 135 may include a turbine wheel (not shown) carried by a shaft 136, 138, respectively, which, in turn, may be rotatably carried by a housing (not shown). The fluid flow path from the exhaust gas outlet 118 to the turbines 133, 135 may include a variable nozzle (not shown) or other variable geometry arrangement adapted to control the velocity of exhaust fluid impinging on the turbine wheels.

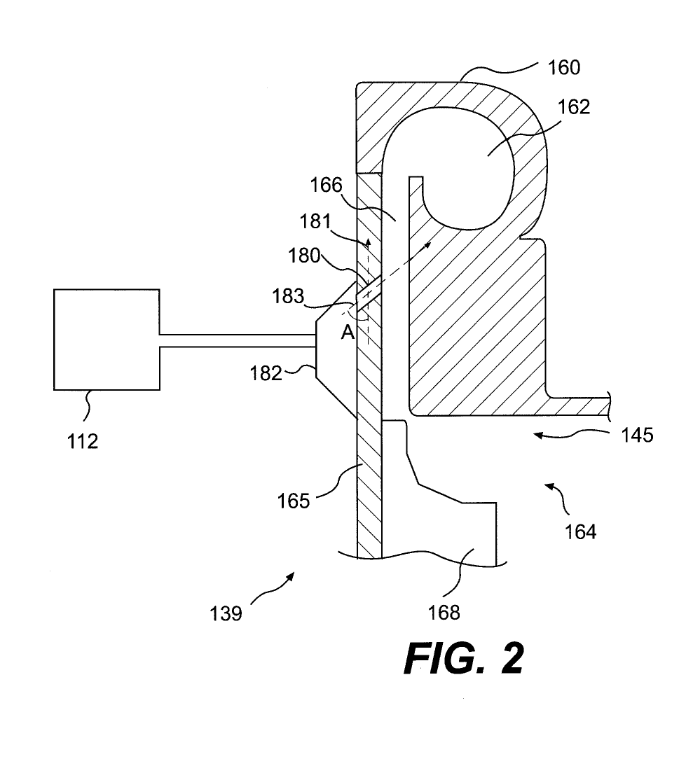

The compressors 137, 139 may each include a compressor impeller wheel (not shown) carried by the shafts 136, 138. Thus, rotation of the shafts 136, 138 by the turbine wheels in turn may cause rotation of the compressor impeller wheels. The inlet 145 of the second compressor 139 may be fluidly connected to the outside of the second compressor 139 for receiving compressor inlet air. The second compressor 139 may further include a diffuser portion fluidly connected to the compressor inlet 145. The structure of the second compressor 139, including the diffuser portion, will be described in detail below with reference to FIG. 2. An inter-conduit 146 is provided between the inlet of the first compressor 137 and the outlet of the second compressor 139 for conducting a compressed air exhaust gas mixture from the second compressor 139 to the first compressor 137.

An intake conduit 126 connects the outlet of the first compressor 137 with the air inlet 116 of the engine 102. The intake conduit 126 may include a pre-cooler 148 and an air-to-air after-cooler (ATAAC) 150 for cooling the compressed air and exhaust gas mixture. The intake manifold 108 provides fluid, for example, air or, in the case of a carbureted engine, a fuel/air mixture, to the combustion cylinders 106.

The internal combustion engine system 100 may further include an exhaust gas recirculation (EGR) system 112 as shown in FIG. 1. The exhaust gas emitted from the exhaust gas outlet 118 may first be introduced into the first turbine 133 to drive the turbine wheel. The exhaust gas exiting the first turbine 133 may be divided into two exhaust gas bypass flows. A first exhaust gas flow may be introduced to the second turbine 135 through the inter-conduit 124. A second exhaust gas may bypass the second turbine 135 and provide exhaust gas to the diffuser portion of the second compressor 139 through an EGR conduit 140 of the EGR system 112. A control valve 125 may be located between the inter-conduit 124 and the EGR conduit 140 to control the amount of exhaust gas supplied to the second compressor 139. The EGR system 112 may include a particulate filter 142 and a cooler 144 disposed in the EGR conduit 140. The filter 142 may be any type of filter, e.g., a diesel particulate filter. The cooler 144 may be any type of cooler, e.g., a clean gas induction cooler. Exhaust gas from the EGR system 112 may alternatively be extracted from an exhaust gas conduit 154 downstream of the second turbocharger 134. However, it should be appreciated that the exhaust gas may be extracted from anywhere in the exhaust gas system, such as the exhaust gas conduit 122.

FIG. 2 shows a cross-sectional view of an embodiment of the second compressor 139 together with the EGR system 112. As shown in FIG. 2, the compressor 139 may include a compressor housing 160 having a backplate 165, an inner chamber 162 (typically referred to as a volute), a diffuser portion 166, a compression chamber 164 in fluid communication with the inner chamber 162 through the diffuser portion 166, and a compressor impeller wheel 168 installed within the compression chamber 164. It is understood that the housing 160 and the backplate 165 may be formed integrally or may be separate components as shown in FIG. 2. The compression chamber 164 may include the inlet 145 for receiving compressor inlet air. The diffuser portion 166 may be located downstream of the air inlet 145. The EGR system 112 may include an EGR plenum 182 coupled to the backplate 165.

The housing 160 may further define a passage 180, which has an outlet in fluid communication with the diffuser portion 166 and an inlet connected to the EGR plenum 182. The EGR system 112 may include a fluid passage 179, which may include at least the plenum 182 and the passage 180. The fluid passage 179 may include an inlet fluidly connected to the outlet 118 of the engine 102, and an outlet fluidly connected to the diffuser portion of one of the first compressor 137 and the second compressor 139. For example, as shown in FIGS. 1 and 2, the outlet of the fluid passage 179 is fluidly connected to the diffuser portion 166 of the compressor 139 and located downstream of the air inlet 145 of the compressor 139. As shown in FIG. 1, the inlet of the fluid passage 179 may be located downstream of the turbine 133. In one embodiment, the diffuser portion 166 may extend along an axis 181 as shown in FIG. 2. In one embodiment, the passage 180 may merge with the diffuser portion 166 at an acute inner angle. For example, the passage 180 may extend along an axis 183 that may be oblique to the diffuser axis 181, and in one embodiment, the diffuser axis 181 and the passage axis 183 may form an angle A, which is equal to or less than 90 degrees such that the passage 180 extends normal to or partially in the same direction as the air flow direction from the compression chamber 164 into the diffuser portion 166. Accordingly, the exhaust gas from the EGR plenum 182 can be introduced into the diffuser portion 166 without being hindered by the air flow in the diffuser portion 166. With this location of passage 180, the compressor impeller wheel 168 will not be contaminated by the exhaust gas entering the second compressor 139 since the exhaust gas is introduced into the diffuser portion 166 downstream of the compressor impeller wheel 168. The engine system 100 may further include one or more filters and/or coolers within the inter-conduit 146 between the second compressor 139 and the first compressor 137 to further clean and/or cool the air and exhaust gas flow from the second compressor 139 to the first compressor 137.

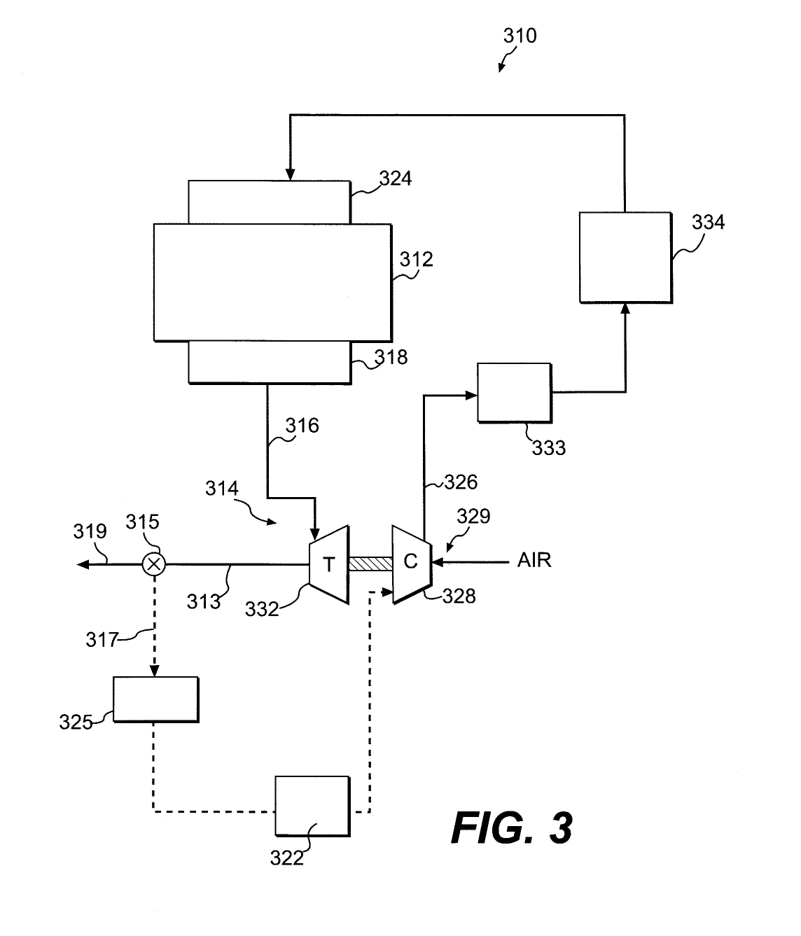

FIG. 3 illustrates another exemplary embodiment of the system for recirculating exhaust gas according to the present disclosure that is in many respects similar to that described above and illustrated in FIG. 1. One of the differences in the embodiment illustrated in FIG. 3 is that the system for recirculating exhaust gas includes only one turbocharger.

As shown in FIG. 3, an engine system 310 includes an engine 312 and a turbocharger 314. The engine 312 may be an internal combustion engine with any type of engine configuration. An exhaust gas conduit 316 may be connected between an engine exhaust manifold 318 of the engine 312 and a turbine 332 of the turbocharger 314. An EGR conduit 317 may be connected between an outlet 313 of the turbine 332 and a diffuser portion of a compressor 328 of the turbocharger 314. Exhaust gas from the EGR system 310 may be extracted from an exhaust gas conduit 319 downstream of the turbine 332. A control valve 315 may be located between the outlet 313 of the turbine 332 and the EGR conduit 317 to control the amount of the exhaust gas directed to the compressor 328. It should be appreciated that the exhaust gas may be extracted from anywhere in the exhaust gas system, such as the exhaust gas conduit 316.

The compressor 328 may embody a structure as shown in FIG. 3. A filter 325 and a cooler 322 may be placed in the bypass conduit 317 for filtering and cooling the exhaust gas before it is introduced to the diffuser portion of the compressor 328. Fresh air is introduced to the compressor 328 through a fresh air inlet 329 of the compressor 328, and is pressurized by the compressor 328. An outlet of the compressor 328 is connected to an inlet manifold 324 of the engine 312 through an inlet conduit 326. In one embodiment, a pre-cooler 333 and an air-to-air after-cooler (ATAAC) 334 may be placed in the inlet conduit 326. The pre-cooler 333 and the after-cooler 334 may be used to cool the mixture of the pressurized fresh air and the exhaust gas exiting the turbocharger compressor 328 before introduction into the intake manifold 324 of the engine 312.

### INDUSTRIAL APPLICABILITY

The disclosed engine system may be applicable to any combustion-type device such as, for example, an engine, a furnace, or any other device known in the art where a recirculation of reduced-particulate gas into an air induction system is desired. The engine system 100 may be a simple, inexpensive, and compact solution to reducing the amount of exhaust emissions discharged to the environment, while protecting the combustion-type device from harmful particulate matter and/or poor performance caused by the particulate matter. The operation of the engine system 100 will now be explained.

During operation of the engine system 100, the engine 102 produces exhaust gas, which exits the engine cylinders 106 through the exhaust manifold 110, forming a flow of exhaust gas. The flow of exhaust gas is transported via the exhaust gas conduit 122 to the first turbocharger 132, driving the turbine wheel in the first turbine 133. The turbine wheel in turn drives the compressor wheel in the first compressor 137. The exhaust gas exists the first turbine 133 through the outlet of the first turbine 133. Part of the output exhaust gas may pass through the inter-conduit 124 between the first turbine 133 and the second turbine 135, and enter the second turbine 135, driving the turbine wheel in the second turbine 135, which in turn drives the compressor wheel in the second compressor 139. The amount of exhaust gas directed to the second turbine 135 may be controlled by the control valve 125 between the inter-conduit 124 and the EGR conduit 140. The exhaust gas delivered to the second turbine 135 may exit via the exhaust gas conduit 154.

The output exhaust gas flowing from the first turbine 133 through the EGR conduit 140 may be filtered or cleaned by the filter 142 and be cooled by the cooler 144. The cooled exhaust gas may then be carried directly to the diffuser portion 166 of the second compressor 139 through the fluid passage 179 including the plenum 182 and the passage 180. Fresh air is suctioned into the second compressor 139 by the compressor wheel 168 of the second compressor 139 and is mixed with the exhaust gas in the diffuser portion 166 of the second compressor 139. The compressor wheel 168 is not contaminated by the exhaust gas since the exhaust gas is introduced to the diffuser portion 166, which is positioned downstream of the compressor wheel 168.

The mixed air may be further cleaned and/or cooled by devices (not shown) in the inter-conduit 146. The mixture is further compressed by the first compressor 137. The output flow from the first compressor 137 passes through the pre-cooler 148 and the ATAAC 150, and is introduced into the engine air inlet 116.

During operation of the engine system 310 of FIG. 3, the engine 312 produces exhaust gas, which exits through the exhaust manifold 318, forming a flow of exhaust gas. The flow of exhaust gas is transported via the exhaust gas conduit 316 to the turbine 332, driving the turbine wheel in the turbine 332. The turbine wheel in turn drives the compressor wheel in the compressor 328. The exhaust gas exists the turbine 332 through the outlet 313 of the turbine 332. An amount of the output exhaust gas, which is controlled by a valve 315 located between the outlet 313 and the EGR conduit 317, may pass through the EGR conduit 317, and is directed to the compressor 328. The exhaust gas may also be delivered out of the engine system 310 via an exhaust gas conduit 319.

In the EGR conduit 317, the exhaust gas may be filtered or cleaned by the filter 325 and cooled by the cooler 322. The cooled exhaust gas may then be carried to the passage 180 of the diffuser portion 166 of the compressor 328. Compressor inlet air is suctioned into the second compressor 328 by the compressor wheel 168 of the compressor 328 and is mixed with the exhaust gas in the diffuser portion 166 of the compressor 328. The compressor wheel 168 is not contaminated by the exhaust gas since the exhaust gas is introduced to the diffuser portion 166, which is positioned downstream of the compressor wheel 168. The mixed air may be further cleaned and/or cooled by devices (not shown) in the inter-conduit 326. The output flow from the compressor 328 passes through the pre-cooler 333 and the ATAAC 334, and is introduced into the engine air inlet 324.

It will be apparent to those skilled in the art that various modifications and variations can be made to the described systems for recirculating exhaust gas in an engine system. Other embodiments will be apparent to those skilled in the art from consideration of the specification and practice of the disclosed systems. It is intended that the specification and examples be considered as exemplary only, with a true scope being indicated by the following claims and their equivalents.

What is claimed is:

1. A system for recirculating exhaust gas in an engine system comprising:
a turbocharger including
a turbine driven by the exhaust gas from an engine, and
a compressor operatively connected to the turbine, the compressor including an air inlet and a diffuser portion located downstream of the air inlet; and
an exhaust gas recirculation system including
a fluid passage having an inlet fluidly connected to an outlet of the engine, and an outlet fluidly connected to the diffuser portion of the compressor and located downstream of the air inlet of the compressor.

2. The system of claim 1, wherein the fluid passage merges with the diffuser portion at an acute inner angle.

3. The system of claim 1, wherein a portion of the fluid passage is located in a backplate of the compressor.

4. The system of claim 3, wherein the fluid passage includes a plenum coupled to and upstream of the backplate of the compressor.

5. The system of claim 1, wherein the inlet of the fluid passage is located downstream of the turbine.

6. A method for providing exhaust gas recirculation for an engine system, the engine system including a turbocharger having a turbine and a compressor operatively connected to the turbine, the compressor including an air inlet and a diffuser portion connected downstream of the air inlet, the method comprising:
emitting exhaust gas from an engine to form a flow of exhaust gas; and
directing at least a portion of the flow of exhaust gas directly into the diffuser portion of the compressor.

7. The method of claim 6, wherein the directing includes directing the flow of exhaust gas into the diffuser portion at an acute inner angle with respect to a direction of fluid flow through the compressor adjacent and upstream of an entry of the exhaust gas into the diffuser portion.

8. The method of claim 6, wherein the directing includes directing the flow of exhaust gas through a backplate of the compressor.

9. The method of claim 8, wherein the directing includes directing the flow of exhaust gas through a plenum coupled to the backplate of the compressor.

10. The method of claim 6, further including receiving air from the outside into the air inlet of the compressor, compressing the air, and mixing the compressed air with the directed exhaust gas in the diffuser portion.

11. The method of claim 10, further including compressing the mixture of compressed air and directed exhaust gas by a second compressor located downstream of the turbocharger compressor.

12. The method of claim 6, further including directing the flow of exhaust gas into the turbine of the turbocharger prior to the directing of at least a portion of the exhaust gas into the diffuser portion.

13. An engine system comprising:
an intake system and an exhaust system, the intake system configured to supply fluid to an engine and the exhaust system configured to receive exhaust gas leaving the engine;
a first turbocharger including a first turbine having an inlet and an outlet, and a first compressor operatively connected to the first turbine and having an inlet and an outlet, the first turbine forming a part of the exhaust system and the first compressor forming a part of the intake system, and the first compressor including a diffuser portion fluidly connected downstream of the inlet of the first compressor;
a second turbocharger including a second turbine having an inlet and an outlet, and a second compressor operatively connected to the second turbine and having an inlet and an outlet, the inlet of the second turbine fluidly connected to the outlet of the first turbine, the outlet of the second compressor fluidly connected to the inlet of the first compressor, wherein the second compressor includes a diffuser portion fluidly connected downstream of the inlet of the second compressor; and
an exhaust gas recirculation system having a fluid passage extending between the exhaust system and the intake system, the fluid passage being directly connected to the diffuser portion of one of the first compressor and the second compressor.

14. The system of claim 13, wherein the fluid passage merges with the diffuser portion at an acute inner angle.

15. The system of claim 13, wherein a portion of the fluid passage is located in a backplate of one of the first compressor and the second compressor.

16. The system of claim 15, wherein the fluid passage includes a plenum coupled to and upstream of the backplate.

17. The system of claim 13, wherein an outlet of the fluid passage directly connects to the diffuser portion of the second compressor.

18. The system of claim 13, wherein an inlet of the fluid passage is located downstream of the first turbine.

19. The system of claim 18, wherein the fluid passage includes a plenum coupled to and upstream of a backplate of the second compressor.

20. The system of claim 13, wherein the engine is a diesel engine.
